(19) United States
(12) Patent Application Publication
(10) Pub. No.: US 2025/0214349 A1
(43) Pub. Date: Jul. 3, 2025

(54) PRINTING METHOD AND PRINTING DEVICE

(71) Applicant: SEIKO EPSON CORPORATION, Tokyo (JP)

(72) Inventor: Masaya USUI, Shiojiri (JP)

(21) Appl. No.: 19/000,764

(22) Filed: Dec. 24, 2024

(30) Foreign Application Priority Data
Dec. 27, 2023 (JP) 2023-220195

(51) Int. Cl. B41J 2/325; B41J 2/01; B41J 2/045; B41J 2/21; B41M 5/382

(52) U.S. Cl. CPC B41J 2/325; B41J 2/04573; B41J 2/21; B41M 5/38257; B41J 2002/012; B41J 2/0458; B41J 2/04581

(57) ABSTRACT

The printing method includes an image forming step for performing a first process that forms an image on a transfer medium by ejecting a colored ink from a first inkjet head and an undercoat forming step for performing a second process including a process of overlaying undercoat ink on the image on the transfer medium by ejecting the undercoat ink from a second inkjet head, wherein assuming that a region where the adhesive is applied to the transfer medium at the same timing in the adhesive application step is a process unit region, in the undercoat forming step, the second process for the process unit region is delayed from an intermediate stage of the second process to completion of the second process.

The present application is based on, and claims priority from JP Application Serial Number 2023-220195, filed Dec. 27, 2023, the disclosure of which is hereby incorporated by reference herein in its entirety.

### BACKGROUND

### 1. Technical Field

The present disclosure relates to a printing method for printing on a transfer medium and a printing device.

### 2. Related Art

As disclosed in JP-A-2014-104595, a method is known for printing on cloth using a transfer sheet as a transfer medium. This printing method includes a step for printing first image data on a transfer sheet using black toner and color toner, a step for generating second image data by processing all colors in the print region of the first image data into black, a step for printing the second image data on the transfer sheet on which the first image data has been printed using white toner instead of black toner, a step for applying adhesive to an uppermost layer of the printed transfer sheet, a step for bonding the transfer sheet to which the adhesive has been applied together with cloth and pressing the cloth while heating, and a step for peeling off a base material of the transfer sheet.

When an image to be transferred to cloth as a transfer target medium is formed using an inkjet printer, it is possible to transfer the image to the cloth by applying powdered hot melt adhesive on the image that was formed by the ink ejected on the transfer sheet. For example, by forming an image of colored ink on the transfer sheet, overlaying white ink on the image, applying the powdered hot melt adhesive on the white ink, and then attaching the heated hot melt adhesive to the cloth, it is possible to transfer the image on the transfer sheet to the cloth. When the white ink lands on the image on the transfer sheet, it gradually dries. In a print region on the transfer sheet, the later the white ink lands, the less dry the white ink is. Therefore, if the transfer sheet is tilted in order to apply the powdered hot melt adhesive or the like, white ink that has not dried sufficiently may drip downward. If the white ink drips downward, the image to be transferred will bleed.

### SUMMARY

A printing method of the present disclosure is a printing method for printing on a transfer medium in order to perform an adhesive application step for applying an adhesive on undercoat ink that was overlaid on an image that was formed on the transfer medium, and to perform a transfer step for transferring the image to a transfer target medium by attaching the adhesive to the transfer target medium, the printing method includes an image forming step for performing a first process that forms the image on the transfer medium by ejecting a colored ink from a first inkjet head and an undercoat forming step for performing a second process including a process of overlaying the undercoat ink on the image on the transfer medium by ejecting the undercoat ink from a second inkjet head, wherein assuming that a region where the adhesive is applied to the transfer medium at the same timing in the adhesive application step is a process unit region, in the undercoat forming step, the second process for the process unit region is delayed from an intermediate stage of the second process to completion of the second process.

A printing device according to the present disclosure is a printing device that prints on a transfer medium in order to perform an adhesive application step that applies an adhesive on undercoat ink that was overlaid on an image that was formed on the transfer medium, and a transfer step that transfers the image to a transfer target medium by attaching the adhesive to the transfer target medium, the printing device includes a first inkjet head that ejects colored ink; a second inkjet head that ejects the undercoat ink; a drive section configured to move the second inkjet head in a first direction relative to the transfer medium; and a control section that controls ejection of the colored ink from the first inkjet head, ejection of the undercoat ink from the second inkjet head, and the drive section, wherein the control section controls a first process that forms the image on the transfer medium by ejecting the colored ink from the first inkjet head, controls a second process that includes a process that overlays the undercoat ink on the image on the transfer medium by ejecting the undercoat ink from the second inkjet head, and assuming that a region where the adhesive is applied to the transfer medium at the same timing in the adhesive application step is a process unit region, performs control that delays the second process for the process unit region from an intermediate stage of the second process to the completion of the second process.

### BRIEF DESCRIPTION OF THE DRAWINGS

FIG. 1 is a diagram schematically showing an example of a configuration of a printing system.

FIG. 2 is a plan view schematically showing an example of a configuration of a printer.

FIG. 3 is a bottom view schematically showing an example of a nozzle surface of an inkjet head.

FIG. 4 is a block diagram schematically showing an example of a configuration of a printing device.

FIG. 5 is a diagram schematically showing an example of a printing method for a transfer target medium.

FIG. 6 is a diagram schematically showing an example of how a process unit region is divided into regions.

FIG. 7 is a diagram schematically showing an example of an intermittent transport in lateral type printing.

FIG. 8 is a diagram schematically showing an example of the process unit region in a cut sheet paper.

FIG. 9 is a flowchart schematically showing an example of a print control process.

FIG. 10 is a diagram schematically showing an example of determining the presence or absence of continuous regions exceeding a reference area.

FIG. 11 is a flowchart schematically showing another example of the print control process together with another example of the structure of a number of passes table.

FIG. 12 is a diagram schematically showing an example of changing number of passes according to the undercoat ink ejection amount per unit area.

### DESCRIPTION OF EMBODIMENTS

Hereinafter, embodiments of the present disclosure will be described. The following embodiment is merely an example of the present disclosure, and not all of the features shown in the embodiment are necessarily essential to solve the disclosure.

### 1. OVERVIEW OF ASPECTS INCLUDED IN THE PRESENT DISCLOSURE

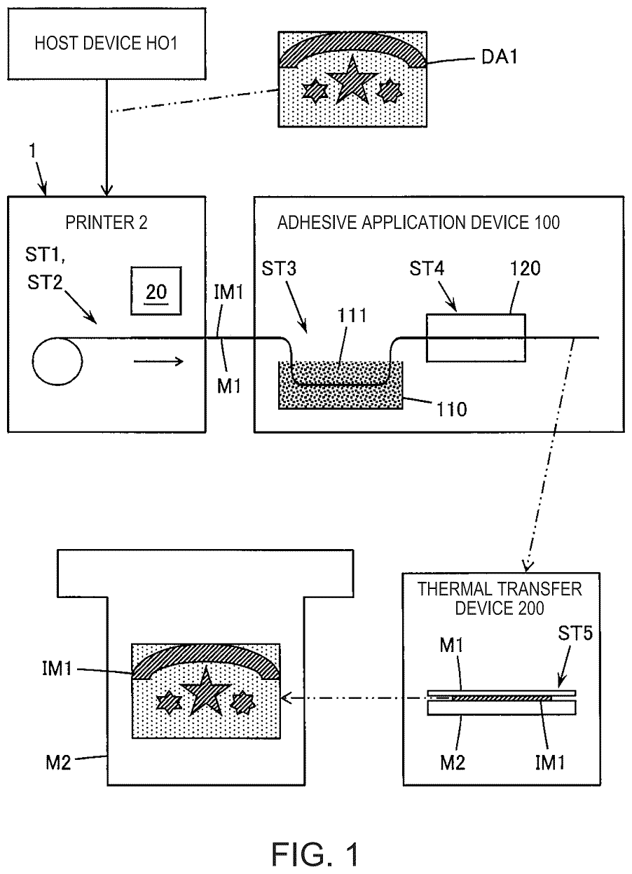

First, the general outline of aspects included in the present disclosure will be explained with reference to the examples shown in FIGS. 1 to 12 Note that the figures in this application are schematic diagrams that show examples, and the scale of each part of these diagrams may differ from the actual scale in order to make each part of these diagrams large enough to be recognizable, and the magnification ratio in the directions shown in these diagrams may differ, and the diagrams may not be consistent. Of course, each element of these aspects is not limited to the specific examples indicated by reference numerals. In the “Overview of aspects included in the present disclosure,” the text in parentheses is a supplementary explanation of the preceding word. In this application, the numerical range “Min to Max” means a value that is equal to or greater than the minimum value Min and that is equal to or less than the maximum value Max.

### Aspect 1

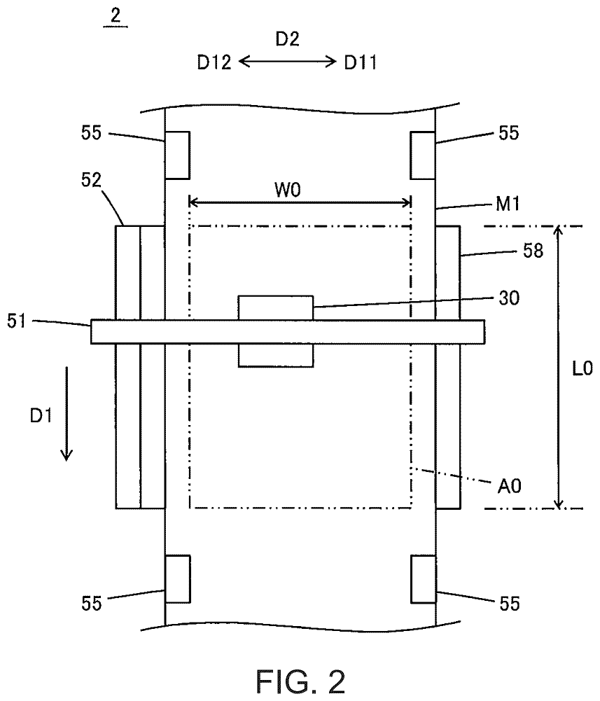

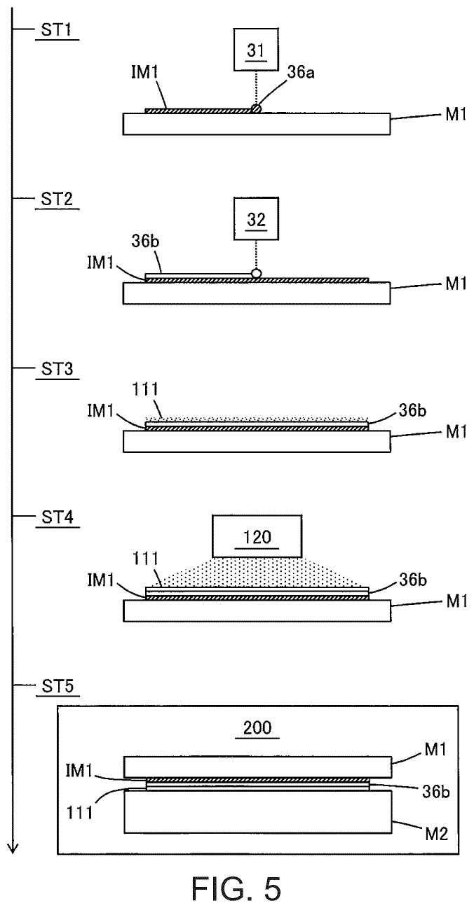

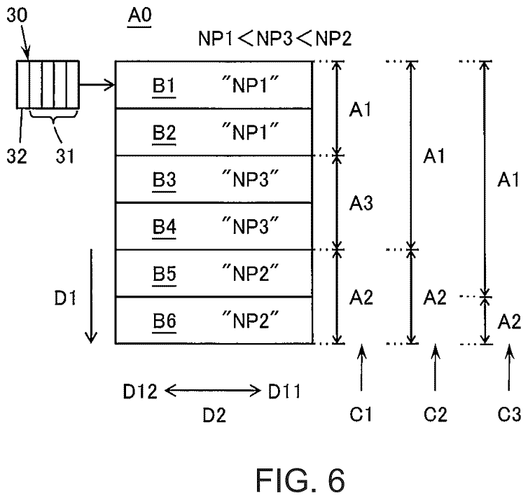

As shown in FIGS. 1, 5, and so on, a printing method according to one aspect is a printing method that performs printing on a transfer medium M1 in order to perform an adhesive application step ST3 for applying adhesive 111 on undercoat ink 36b that was overlaid on an image IM1 that was formed on the transfer medium M1, and a transfer step ST5 for transferring the image IM1 to a transfer target medium M2 by attaching the adhesive 111 to the transfer target medium M2. The present printing method includes the following steps. (a1) An image forming step ST1 for performing a first process that forms the image IM1 on the transfer medium M1 by ejecting colored ink 36a from a first inkjet head (for example, a colored ink head 31). (a2) An undercoat forming step ST2 for performing a second process that includes a process of moving a second inkjet head (for example, an undercoat ink head 32) relative to the transfer medium M1 in the first direction D1 and a process of overlaying the undercoat ink 36b on the image IM1 by ejecting the undercoat ink 36b from a second inkjet head (32). Here, as shown in FIGS. 2, 6, and so on, a region in which the adhesive 111 is applied to the transfer medium M1 at the same timing in the adhesive application step ST3 is defined as a process unit region A0. In the undercoat forming step ST2, the second process for the process unit region A0 is delayed from an intermediate stage of the second process to completion of the second process.

Due to the delay in the second process from the intermediate stage to the completion of the second process for the process unit region A0 above, drying of the undercoat ink 36b in a portion of the process unit region A0 where the undercoat ink 36b is lastly overlaid on the image IM1 progresses. By this, flow of the undercoat ink 36b due to tilting of the transfer medium M1 in the adhesive application step ST3 is suppressed, and bleeding of the transfer image (the image IM1 to be transferred) due to the undercoat ink 36b dripping downward or the like is suppressed. Therefore, the above aspect can provide a printing method that is capable of suppressing bleeding of the transfer image.

Various examples of the above aspect are conceivable. Moving the second inkjet head (32) in the first direction D1 relative to the transfer medium M1 includes moving the second inkjet head (32) in the first direction D1 without moving the transfer medium M1, moving the transfer medium M1 in a direction opposite to the first direction D1 without moving the second inkjet head (32), and moving both the transfer medium M1 and the second inkjet head (32) in the first direction D1. The second inkjet head (32) may also move relative to the transfer medium M1 in a second direction D2 that intersects the first direction D1. The first inkjet head (31) may move relative to the transfer medium M1 together with the second inkjet head (32), or it may move relative to the transfer medium M1 independently of the second inkjet head (32).

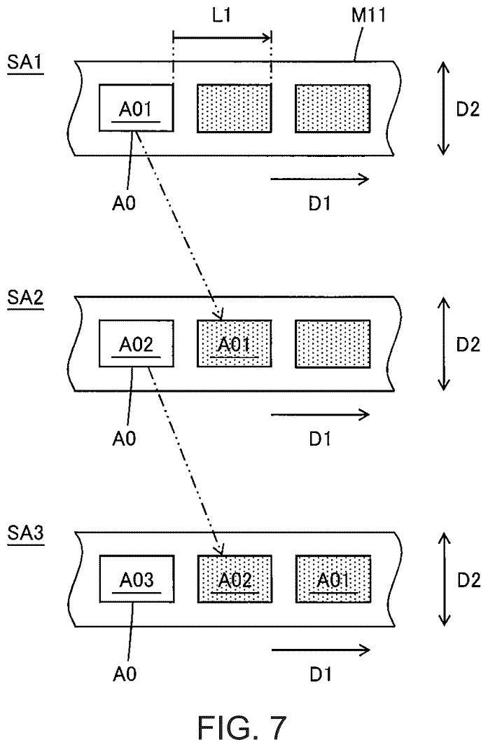

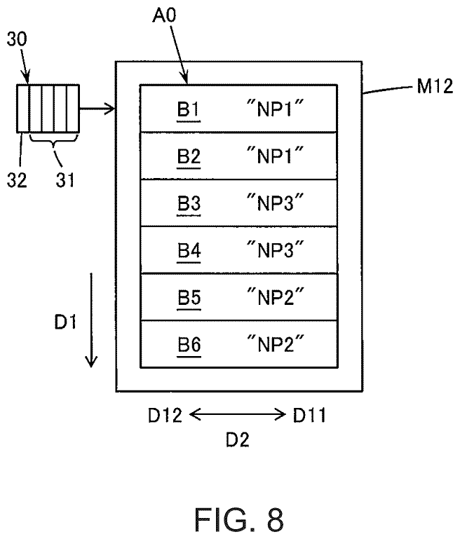

The process unit region A0 includes the following regions.
(region b1) In a case where the transfer medium is a cut sheet paper, a region corresponding to one single cut sheet paper (for example, see FIG. 8).
(region b2) In a case where the transfer medium, which is continuous paper on which lateral type printing is performed, is transported intermittently, a region corresponding to a single transport amount (for example, see FIG. 7).
(region b3) In a case where a sub-scanning is performed for the transfer medium on which serial type printing is performed, a region corresponding to a transport amount for one sub-scanning.
(region b4) In a case where the transfer medium on which line type printing was performed is cut, a region corresponding to a single cut transfer medium.

Note that the printing on the cut sheet paper may be performed by any one of lateral type printing, serial type printing, and line type printing. Lateral type printing is a printing method in which an inkjet head ejects ink while moving the inkjet head in a main scanning direction and a sub-scanning direction that intersects the main scanning direction in the process unit region of the transfer medium. Lateral type printing for continuous paper is a printing method in which an inkjet head ejects ink while moving the inkjet head, with respect to the above region b2 of the transfer medium that was stopped, in the transport direction and a direction that intersects the transport direction, and in which the continuous paper is intermittently transported in the transport direction in units corresponding to the above region b2. Serial type printing is a printing method in which an inkjet head ejects ink while moving the inkjet head reciprocally in a main scanning direction, and a sub-scanning is performed between main scannings. Line type method is a printing method in which an inkjet head, which has a length equal to or longer than a width of a continuous paper, ejects ink to the continuous paper being transported. The material of the cut sheet paper and the continuous paper is not strictly limited to paper, and may be resin, metal, or the like.

In the undercoat forming step ST2, the second inkjet head (32) that is being moved relatively in the first direction D1 may eject undercoat ink 36b or the second inkjet head (32) that is being moved relatively in the second direction D2 without changing the relative position in the first direction D1 may eject the undercoat ink 36b. The second process may be a combination of a process of overlaying the undercoat ink 36b on the image IM1 while performing main scannings along the second direction D2, and a process of performing sub-scannings in the first direction D1. The second process may also be a combination of a process of overlaying the undercoat ink 36b on the image IM1 while performing the main scannings along the first direction D1 and a process of performing the sub-scannings in the second direction D2. The second process may also be a process of overlaying the undercoat ink 36b on the image IM1 while transporting the transfer medium M1 in a direction opposite to the first direction D1. The delay of the second process includes an increase in the number of passes NP, which means the number of times of main scannings that accompanies ejection of the undercoat ink 36b in the same portion on the transfer medium M1, an increase in the processing time of a sub-scanning, an increase in the processing time of a main scanning, and the like. In this application, “first”, “second”, and so on are terms for identifying components included in a plurality of components having a similar point, and do not mean an order. Of course, the above additional remark also applies to the following aspects.

### Aspect 2

As shown in FIG. 6 and so on, the process unit region A0 may include a first region A1 and a second region A2 where the undercoat ink 36b is overlaid on the image IM1 after the first region A1. The second region A2 may include a portion where the undercoat ink 36b is lastly overlaid on the image IM1 in the process unit region A0. In the present printing method, in the undercoat forming step ST2, the second process for the second region A2 may be delayed. Drying time for the undercoat ink 36b in the above second region A2 is less than that in the first region A1. By delaying the second process for the second region A2 not the first region A1, flow of the undercoat ink 36b is suppressed due to tilting of the transfer medium M1 in the adhesive application step ST3. Therefore, in the above aspect, it is possible to suppress bleeding of the transfer image while suppressing a decrease in throughput as much as possible.

The process unit region A0 may include a third region A3 in which the undercoat ink 36b is overlaid on the image IM1 after the first region A1 and before the second region A2. In this case, in the undercoat forming step ST2, the second process for the third region A3 may be delayed, and then the second process for the second region A2 may be further delayed. The above additional remark also applies to the following aspects.

### Aspect 3

As shown in FIG. 6 and so on, in the undercoat forming step ST2, the present printing method may perform the second process of performing a main scanning that ejects the undercoat ink 36b while moving the second inkjet head (32) relative to the transfer medium M1 along a second direction D2, which intersects the first direction D1, and of changing a position in the first direction D1 where the undercoat ink 36b is overlaid on the image IM1 by moving the second inkjet head (32) relative to the transfer medium M1 during a sub-scanning between main scannings. Here, the number of times of the main scannings that accompanies ejection of the undercoat ink 36b that is performed at the same portion on the transfer medium M1, is defined as the number of passes NP. In the present printing method, in the undercoat forming step ST2, the second process may be performed so that the number of passes NP for the second region A2 becomes greater than the number of passes NP for the first region A1. The greater the number of passes NP for the second region A2 is, the longer the time required for the second process for the second region A2 will be. By this, the second process is delayed from the start time of the second process for the second region A2, and drying of the undercoat ink 36b will progress. If the ejection of the undercoat ink 36b is divided into NP times of main scannings, an ejection amount of the undercoat ink 36b per single main scanning will be less for the second region A2 than for the first region A1, and the undercoat ink 36b will dry more. When drying of the undercoat ink 36b progresses, flow of the undercoat ink 36b due to tilting of the transfer medium M1 in the adhesive application step ST3 is suppressed. Therefore, in the above aspect, it is possible to suppress bleeding of the transfer image by a simple method of changing the number of passes for each region.

### Aspect 4

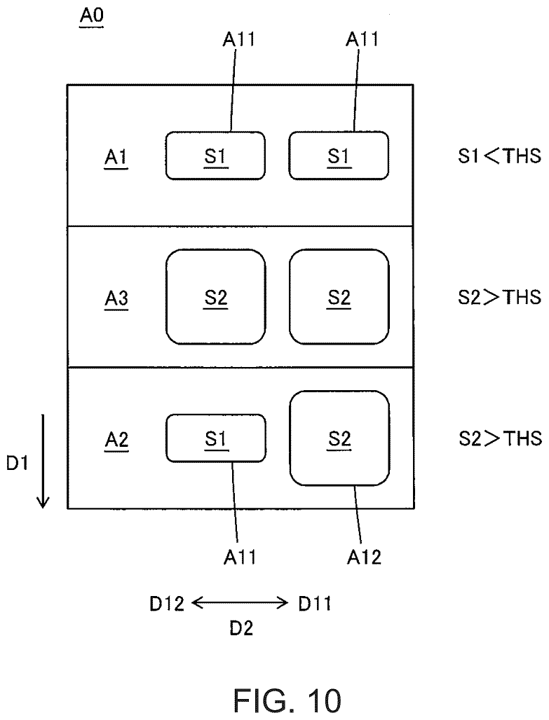

As shown in FIG. 10, the process unit region A0 may include a continuous region (for example, a first continuous region A11 or a second continuous region A12) connected as one image as the image IM1. In the undercoat forming step ST2, the present printing method may make the number of passes NP when there is a continuous region (A12) that exceeds a reference area THS in at least one of the first region A1 and the second region A2 greater that the number of passes NP when there is no continuous region (A12) that exceeds the reference area THS. The larger the continuous region (A11, A12) is, the more easily flow of the undercoat ink 36b occurs due to tilting of the transfer medium M1 in the adhesive application step ST3. When there is a large area continuous region (A12) in the first region A1 or the second region A2, the number of passes NP increases compared to when there is no large area continuous region (A12), so flow of the undercoat ink 36b due to tilting of the transfer medium M1 in the adhesive application step ST3 is further suppressed. Therefore, in the above aspect, bleeding of the transfer image can be further suppressed.

### Aspect 5

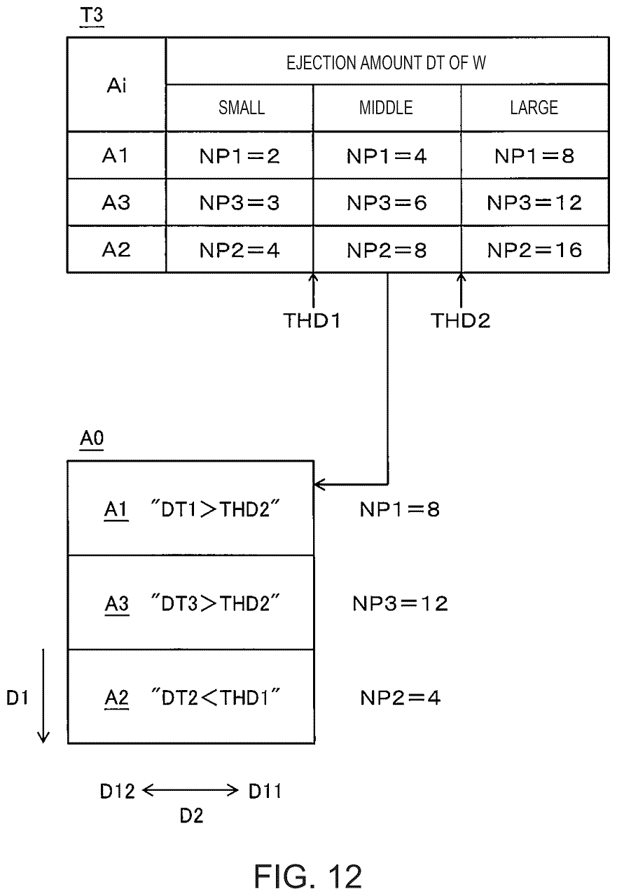

As shown in FIG. 12, in the undercoat forming step ST2, the present printing method may perform the second process that makes the number of passes NP when the ejection amount DT of the undercoat ink 36b per unit area exceeds a first ejection amount THD1 in at least one of the first region A1 and the second region A2 greater than the number of passes NP when the ejection amount DT of the undercoat ink 36b per unit area does not exceed the first ejection amount THD1, and that makes the number of passes NP for the second region A2 greater than the number of passes NP for the first region A1 if the ejection amount DT of the undercoat ink 36b per unit area is not changed. The greater the ejection amount DT of the undercoat ink 36b per unit area is, the more likely it is that the undercoat ink 36b will flow due to tilting of the transfer medium M1 in the adhesive application step ST3. As the number of passes NP increases for a region where the ejection amount DT of the undercoat ink 36b is high, drying of the undercoat ink 36b progresses. Therefore, flow of the undercoat ink 36b due to titling of the transfer medium M1 in the adhesive application step ST3 is further suppressed. If the ejection amount DT of the undercoat ink 36b does not change, the number of passes NP in the second region A2 will be greater than the number of passes NP in the first region A1. By this, the second process for the second region A2 is delayed from the start time of the second process for the second region A2, and drying of the undercoat ink 36b progresses. Therefore, in the above aspect, bleeding of the transfer image can be further suppressed.

Note that the ejection amount DT of the undercoat ink 36b per unit area means a ratio (including percentage) of the number of dots formed by ink droplets 37 with respect to a predetermined number of pixels. In a case when dots of different sizes were formed, this ratio will be a ration of that when those dots are converted into the largest dot (for example, a large dot). A pixel is the smallest component of an image to which a color can be applied independently. For example, when Nd number of large dots are formed in 100 pixels, the ejection amount DT will be Nd %. The above additional remark also applies to the following aspects.

### Aspect 6

The undercoat ink 36b may be an ink containing component that blocks transmission of light. In this case, the color of the transfer target medium M2 is not seen through the image portion, so that the image quality of the transfer image can be improved. Here, the ink containing a component that blocks transmission of light includes an ink that contains a component that diffusely reflects light, such as white ink, an ink that contains a component that absorbs light, such as black ink, and an ink that contains a component that diffusely reflections and absorbs light, such as gray ink. This additional remark also applies to the following aspects.

### Aspect 7

As shown in FIGS. 1 and 5, the printing device 1 according to one aspect is a printing device 1 that performs printing on the transfer medium M1 in order to perform an adhesive application step ST3 that applies the adhesive 111 on the undercoat ink 36b that was overlaid on the image IM1 that was formed on the transfer medium M1, and to perform a transfer step ST5 that transfers the image IM1 to the transfer target medium M2 by attaching the adhesive 111 to the transfer target medium M2. As shown in FIGS. 2 to 4, the printing device 1 is equipped with a first inkjet head (31) that ejects colored ink 36a, a second inkjet head (32) that ejects undercoat ink 36b, a drive section 50, and a control section 10. The drive section 50 moves the second inkjet head (32) in the first direction D1 relative to the transfer medium M1. The control section 10 controls ejection of the colored ink 36a from the first inkjet head (31), ejection of the undercoat ink 36b from the second inkjet head (32), and the drive section 50. As shown in FIG. 5, the control section 10 controls the first process of forming the image IM1 on the transfer medium M1 by ejecting the colored ink 36a from the first inkjet head (31). The control section 10 controls the second process that includes a process of moving the second inkjet head (32) in the first direction D1 relative to the transfer medium M1 and a process of ejecting the undercoat ink 36b from the second inkjet head (32) to overlay the undercoat ink 36b on the image IM1. Here, it will be assumed that a region where the adhesive 111 is applied to the transfer medium M1 at the same timing in the adhesive application step ST3 is a process unit region A0. The control section 10 performs control that delays the second process for the process unit region A0 from an intermediate stage of the second process to completion of the second process.

According to the above aspect, it is possible to provide a printing device that can suppress bleeding of a transfer image.

The above aspect can be applied to a printing system including the above printing device, a method for controlling the above printing device, a method for controlling the above printing system, a control program for the above printing device, a control program for the above printing system, a computer-readable recording medium on which any of the above programs is recorded, and the like. The above printing device may also be configured with multiple distributed components.

### 2. SPECIFIC EXAMPLE OF PRINTING DEVICE

FIG. 1 schematically shows a configuration of a printing system that forms an image IM1 on a transfer medium M1 and transfers the image IM1 to a transfer target medium M2. The printing system shown in FIG. 1 includes a printing device 1, an adhesive application device 100, and a thermal transfer device 200. The printing device 1 may be configured with a single printer 2, but as shown in FIG. 1, it may also be configured with a printer 2 and a host device HO1. The host device HO1 shown in FIG. 1 can generate image data DA1 corresponding to the image IM1 to be transferred, and can transmit the image data DA1 to the printer 2. Hereinafter, the image IM1 to be transferred is also referred to as a transfer image IM1. The printer 2 is equipped with a printing section 20 that ejects ink onto the transfer medium M1, and forms an image IM1 corresponding to the image data DA1 on the transfer medium M1. The adhesive application device 100 is equipped with an adhesive tank 110 that applies adhesive 111 to the ink on the transfer medium M1, and a heating section 120 that heats the transfer medium M1 after the adhesive has been applied. The thermal transfer device 200 transfers the image IM1 from the transfer medium M1 to the transfer target medium M2.

As the transfer medium M1, a transfer film or the like that can transfer an image using a direct to film (DTF) method can be used. As such a transfer film, a resin file such as a polyethylene terephthalate (PET) film or the like can be suitably used. Of course, the material of the transfer medium M1 may include paper, metal, or the like in addition to resin, and the transfer medium M1 may be a metal film or the like. As the adhesive 111, a powdered adhesive such as powdered hot melt adhesive can be used. Hot melt adhesive is a thermoplastic resin powder that melts when heated above its melting point and that solidifies when cooled. As the hot melt adhesive, an adhesive containing one or more thermoplastic resins selected from polyurethane resin, polyolefin resin, polyamide resin, polyester resin, and the like can be used. As the transfer target medium M2, fabrics such as knitted or woven cloth and non-woven cloth can be used, and processed fabrics such as a T-shirt can also be used.

As will be described in detail later, the image forming step ST1 and the undercoat forming step ST2 are performed in the printing device 1. The adhesive application step ST3 and the heating step ST4 are performed in the adhesive application device 100. The transfer step ST5 is performed in the thermal transfer device 200.

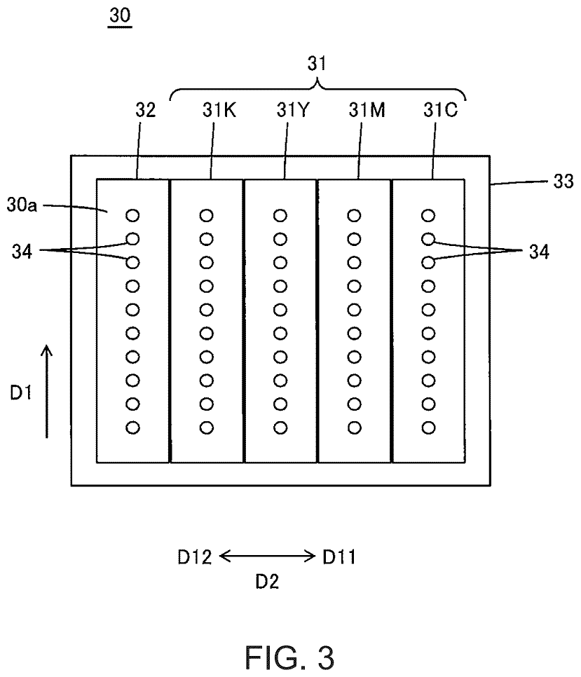

FIG. 2 plan view schematically showing a configuration of the printer 2 having an inkjet head 30. Note that the process unit region A0 shown in FIG. 2 is a rectangular region with a length L0 and a width WO. FIG. 3 is a bottom view schematically showing a nozzle surface 30a of the inkjet head 30.

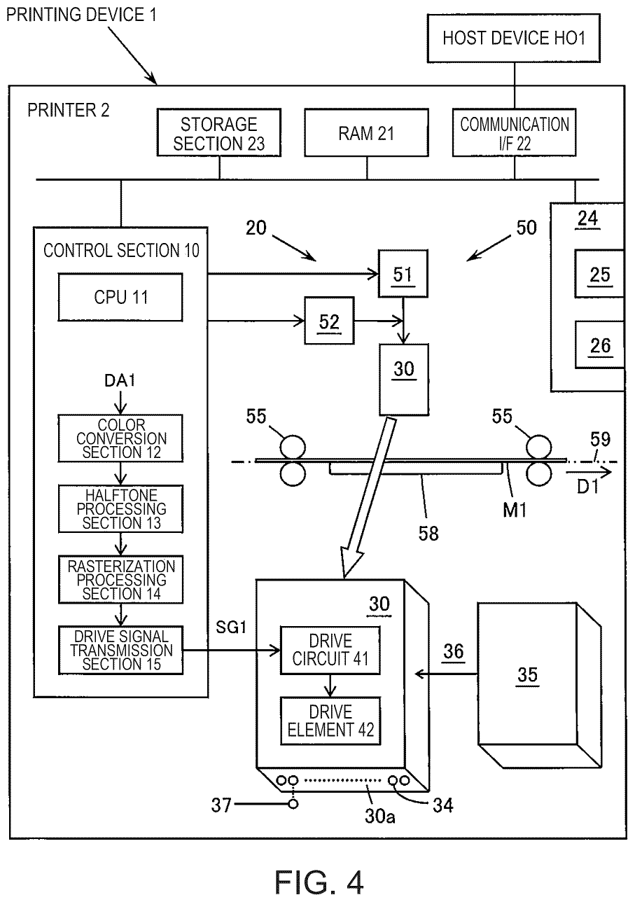

FIG. 4 is a block diagram schematically showing the configuration of the printing device 1. FIG. 5 schematically shows the printing method on the transfer target medium M2. FIG. 6 schematically shows an example of how the process unit region A0 is divided into regions. The printer 2 is an inkjet printer that ejects ink droplet 37 in liquid form. The printer 2 is equipped with a control section 10, a printing section 20, a random access memory (RAM) 21, which is a semiconductor memory, a communication interface (I/F) 22, a storage section 23, an operation panel 24, and the like. The control section 10, the RAM 21, the communication I/F 22, the storage section 23, and the operation panel 24 are connected to a bus so as to be able to input and output information to and from each other. The printing section 20 has an inkjet head 30 and a drive section 50.

The control section 10 has a central processing unit (CPU) 11, which is a processor, a color conversion section 12, a halftone processing section 13, a rasterization processing section 14, a drive signal transmission section 15, and the like. The control section 10 can be configured by a system on a chip (SoC) or the like. Based on the image data DA1 acquired from any one of the host device HO1, an external memory (not shown), and the like, the control section 10 controls the inkjet head 30 and the drive section 50 so that the image IM1 with the colored ink 36a and a layer with the undercoat ink 36b are formed on the transfer medium M1. As the image data DA1, for example, RGB data that has integer values representing 28 levels of grayscale for R (red), G (green), and B (blue) can be applied to each pixel.

The CPU 11 is a device that mainly performs information processing and control in the printer 2. The color conversion section 12 has, for example, a color conversion LUT (look-up table) in which a correspondence relationship between the grayscale values of R, G, and B and the grayscale values of C (cyan), M (magenta), Y (yellow), K (black), and W (white) is defined. The grayscale value of W in the color conversion LUT is, for example, a value that is used for the undercoat ink 36b when at least one colored ink 36a of C, M, Y, and K is used. As an example, in a case where the grayscale values of C, M, Y, and K are 0, which indicates that colored ink is not used, the grayscale value of W may be 0, which indicates that the undercoat ink is not used, and in the remaining cases, the grayscale value of W may be 128, which indicates that 50% of the undercoat ink is used. By this, the undercoat ink 36b is overlaid at a location of the image IM1. Of course, the ejection amount of the undercoat ink 36b, which is overlaid on the image IM1, may be less than 50%, may be more than 50%, and may be changed according to the color of the image IM1, as long as the transfer image IM1 with a desirable image quality can be obtained. The color conversion section 12 refers to the color conversion LUT and converts the RGB data into ink amount data that has integer values of, for example, 2⁸ grayscales of C, M, Y, and K for each pixel. The ink amount data represents a usage amount of C, M, Y, K, and W ink 36 in units of pixels. Note that the ink 36 shown in FIG. 4 includes the colored inks 36a of C, M, Y, and K, and the undercoat ink 36b. If resolution of the RGB data is different from printing resolution, the color conversion section 12 first converts the resolution of the RGB data to the printing resolution or converts resolution of the ink amount data to the printing resolution.

By performing halftone processing on the ink amount data using any of a dither method, an error diffusion method, and the like, the halftone processing section 13 generates dot data whose number of grayscale levels is reduced, for example 2 or 4. The dot data is generated for each of C, M, Y, K, and W. The dot data represents the formation state of dots of ink 36 in units of pixels. The rasterization processing section 14 generates raster data by performing a rasterizing process that rearranges the dot data in the order in which dots are formed by the drive section 50.

The drive signal transmission section 15 generates, from the raster data, a drive signal SG1 corresponding to a voltage signal to be applied to a drive element 42 of the inkjet head 30 and outputs the drive signal SG1 to a drive circuit 41 of the inkjet head 30. The RAM21 stores the image data DA1 and the like received from the host device HO1 and the like. The communication I/F 22 inputs and outputs information to and from the host device HO1 or the like. Examples of the host device HO1 include computers such as personal computers or tablet terminals, mobile phones such as smartphones, and the like. The storage section 23 may be a nonvolatile semiconductor memory such as a flash memory, or a magnetic storage device such as a hard disk. The operation panel 24 is equipped with an output section 25 such as a liquid crystal panel that displays information, an input section 26 such as a touch panel that receives operations on a display screen, and the like.

The drive circuit 41 applies a voltage signal to the drive element 42 in accordance with the drive signal SG1 input from the drive signal transmission section 15. The drive element 42 may be a piezoelectric element that applies pressure to the ink 36 in a pressure chamber communicating with the nozzles 34, or it may be a drive element that generates bubbles in the pressure chamber by heat and ejects the ink droplet 37 from the nozzles 34. The ink 36 is supplied from an ink cartridge 35 to the pressure chamber of the inkjet head 30. The ink 36 in the pressure chamber is ejected as the ink droplet 37 from the nozzles 34 toward the transfer medium M1 by the drive element 42. When the ink droplet 37 lands on the transfer medium M1, a dot is formed on the transfer medium M1. When dots of the colored ink 36a are formed on the transfer medium M1, an image IM1 represented by a pattern of the dots is formed on the transfer medium M1.

The inkjet head 30 shown in FIG. 3 includes a colored ink head 31 that ejects the colored ink 36a and an undercoat ink head 32 that ejects the undercoat ink 36b. The colored ink head 31 is an example of a first inkjet head, and the undercoat ink head 32 is an example of a second inkjet head. The colored ink 36a is an ink that contains colorants, which are called pigments, as a dispersed substance or a solute in a liquid (for example, water) as a dispersant or a solvent. The colored ink 36a includes, for example, chromatic inks of C, M, and Y, and an achromatic ink of K. The colored ink head 31 includes a C ink head 31C that ejects C ink, an M ink head 31M that ejects M ink, a Y ink head 31Y that ejects Y ink, and a K ink head 31K that ejects K ink. The undercoat ink 36b is an ink that contains a component that blocks transmission of light, for example, a W ink that contains a component that diffusely reflects light. The W ink is, for example, an ink that contains a white pigment such as titanium oxide or zinc oxide as dispersed substance in a liquid such as water as a dispersant. Since the undercoat ink 36b blocks the transmission of light, the color of the transfer target medium M2, which serves as the background of the image IM1, does not affect the color of the image IM1, and the transfer target medium M2 that has an image IM1 of good image quality is obtained. Each of the ink heads (31C, 31M, 31Y, 31K, 32) has a nozzle array in which a plurality of nozzles 34 are arranged in a nozzle arrangement direction that intersects the second direction D2 as a scanning direction, for example, in the first direction D1. The plurality of nozzles 34 of each ink head may be arranged in a staggered pattern in the nozzle arrangement direction, in other words, arranged in two rows in the nozzle arrangement direction. The nozzle alignment direction may be shifted from the first direction D1 within a range of less than 90 degrees. Each nozzle 34 of the colored ink head 31 ejects the colored ink 36a as an ink droplet 37, and each nozzle 34 of the undercoat ink head 32 ejects the undercoat ink 36b as an ink droplet 37. The inkjet head 30 shown in FIGS. 2 to 4 is mounted on a carriage 33. When the printer 2 performs lateral type printing, the carriage 33 is movable along the second direction D2 as a main scanning direction and the first direction D1 as a sub-scanning direction.

The drive section 50 in the lateral type printing is equipped with a main scanning drive section 51, a sub-scanning drive section 52, and a transport section 55. The main scanning drive section 51 shown in FIG. 2 performs a main scanning that ejects ink 36 from the inkjet head 30 in at least one of scannings in a forward direction D11 and a return direction D12 while moving the inkjet head 30 along the second direction D2 as the main scanning direction. In terms of the undercoat ink head 32, it can be said that the main scanning drive section 51 performs the main scanning that ejects the undercoat ink 36b while moving the undercoat ink head 32 relative to the transfer medium M1 along the second direction D2. The sub-scanning drive section 52 shown in FIG. 2 performs a sub-scanning that moves, between main scannings, the inkjet head 30 along the first direction D1 as the sub-scanning direction. In other words, during the sub-scanning, the inkjet head 30 intermittently moves along the first direction D1. In terms of the undercoat ink head 32, it can be said that the sub-scanning drive section 52 moves the undercoat ink head 32 in the first direction D1 relative to the transfer medium M1 during the sub-scanning between main scannings. The transport section 55 shown in FIG. 2 transports the transfer medium M1, which is continuous paper, along the first direction D1 as the transport direction between printing of the process unit regions A0. In other words, during non-printing, the transfer medium M1 is intermittently moved along the first direction D1. The transport section 55 shown in FIGS. 2 and 4 transports the transfer medium M1 in the first direction D1 along a transport path 59. A platen 58 is located below the transport path 59 and supports the transfer medium M1 by contacting the transfer medium M1 in the transport path 59. The inkjet head 30, which is controlled by the control section 10, ejects the ink droplet 37 toward the transfer medium M1 that is supported by the platen 58 to deposit the ink 36 on the transfer medium M1. The control section 10 controls ejection of the colored ink 36a from the colored ink head 31, ejection of the undercoat ink 36b from the undercoat ink head 32, and the drive section 50.

Note that various arrangements of the undercoat ink head 32 are conceivable as long as the undercoat ink 36b can be overlaid on the image IM1 formed by the colored ink 36a. For example, the undercoat ink head 32 may be located in the forward direction D11 side from the C ink head 31C shown in FIG. 3, or it may be located in an opposite direction side to the sub-scanning direction from the colored ink head 31.

Next, referring to FIGS. 5, 6, and so on, a printing method for the transfer target medium M2 will be described. The printing method shown in FIG. 5 includes the following steps.
(c1) An image forming step ST1 for performing an image forming process that forms the image IM1 on the transfer medium M1 by ejecting the colored ink 36a from the colored ink head 31.
(c2) An undercoat forming step ST2 for performing an undercoat forming process that includes a process that moves the undercoat ink head 32 relative to the transfer medium M1 in the first direction D1 and a process that overlays the undercoat ink 36b on the image IM1 by ejecting the undercoat ink 36b from the undercoat ink head 32.
(c3) An adhesive application step ST3 for applying the adhesive 111 on the undercoat ink 36b that was overlaid on the image IM1 that was formed on the transfer medium M1.
(c4) A heating step ST4 for heating the transfer medium M1 on which the adhesive 111 was applied.
(c5) A transfer step ST5 for transferring the image IM1 to the transfer target medium M2 by attaching the adhesive 111 to the transfer target medium M2. Note that the image forming process is an example of the first process, and the undercoat forming process is an example of the second process.

For example, as shown in FIG. 6, it is assumed that ink 36 is ejected from the inkjet head 30 to the process unit region A0 in units of bands B1 to B6. For example, in a case where, for each band, a first main scanning in which the colored ink 36a is applied is performed and then a second main scanning in which the undercoat ink 36b is applied is performed, the image forming step ST1 is performed in the first main scanning, and the undercoat forming step ST2 is performed in the second main scanning. If the first main scanning is a main scanning in the forward direction D11, the second main scanning may be a main scanning in the return direction D12 as in bidirectional printing, or the second main scanning may be a main scanning in the forward direction D11 as in unidirectional printing. As long as the undercoat ink 36b is overlaid on the image IM1 that was formed with the colored ink 36a without mixing, the image forming step ST1 and the undercoat forming step ST2 may be performed in a single main scanning in the forward direction D11 using the inkjet head 30 shown in FIG. 3. For each band, the image IM1 may be formed in one pass, the undercoat ink 36b may be overlaid on the image IM1 in one pass, the image IM1 may be formed in multiple passes, or the undercoat ink 36b may be overlaid on image IM1 in multiple passes.

In the example shown in FIG. 1, the transfer medium M1 on which the undercoat ink 36b was overlaid on the image IM1 is intermittently transported from the printer 2 to the adhesive application device 100, and is tilted and introduced into the adhesive tank 110. When the adhesive tank 110 contains adhesive 111 in powder form, the adhesive 111 adheres to the undercoat ink 36b that has not dried yet. FIG. 5 shows, in the adhesive application step ST3, a state of the transfer medium M1 on which the image IM1, the undercoat ink 36b, and the powdered adhesive 111 are layered in this order on the transfer medium M1. In this way, the adhesive application step ST3 is performed. In the example shown in FIG. 1, the transfer medium M1 on which the thermoplastic adhesive 111 was applied is intermittently transported from the adhesive tank 110 to the heating section 120. During this time, the excess adhesive 111 is shaken off as the transfer medium M1 is tilted again or the like. The heating section 120 heats the transfer medium M1 on which the adhesive 111 was applied. When the transfer medium M1 is heated to a temperature equal to or greater than the melting temperature of the adhesive 111, the adhesive 111 melts. FIG. 5 shows, in the heating step ST4, a state of the transfer medium M1 on which the image IM1, the dried undercoat ink 36b, and the melted adhesive 111 are layered in this order on the transfer medium M1. If the thermal transfer device 200 can heat the transfer medium M1, the heating section 120 may preheat the transfer medium M1 to a temperature lower than the melting temperature of the adhesive 111. In this way, the heating step ST4 is performed. In the example shown in FIG. 1, the heated transfer medium M1 is intermittently deposited from the heating section 120. The discharged transfer medium M1 is cut as necessary, the transfer medium M1 is placed on the transfer target medium M2 so that a surface to which the adhesive 111 was applied faces the transfer target medium M2, and the transferred medium M1 is transported into the thermal transfer device 200.

The thermal transfer device 200 pressurizes the transfer medium M1 and the transfer target medium M2 in a state in which the adhesive 111 that was applied to the transfer medium M1 is in contact with the transfer target medium M2. If the thermal transfer device 200 is equipped with a heating mechanism, the thermal transfer device 200 heats the transfer medium M1 and the transfer target medium M2 to a temperature equal to or greater than the melting temperature of the adhesive 111. FIG. 5 shows a state where the melted adhesive 111, the dried undercoat ink 36b, the image IM1, and the transfer medium M1 are laminated in this order on the transfer target medium M2. By pressurizing the transfer medium M1 and the transfer target medium M2, the image IM1 is attached to the transfer target medium M2 via the undercoat ink 36b and the adhesive 111. In this way, the transfer step ST5 that transfers the image IM1 to the transfer target medium M2 is performed. When the transfer medium M1 is peeled off from the transfer target medium M2, the image IM1 remains on the transfer target medium M2 and, as shown in FIG. 1, the transfer target medium M2 to which the image IM1 has been transferred is obtained. Since there is an undercoat ink 36b layer between the transfer image IM1 and the transfer target medium M2, the color of the transfer target medium M2 is suppressed from affecting the image IM1, and the image IM1 has good image quality.

Although the above-described transfer medium M1 is continuous paper, the transfer medium M1 may also be cut sheet paper. In this case, the user may put the printed cut sheet paper into the adhesive tank 110 to apply the powdered adhesive 111 to the undercoat ink 36b. In this operation, the transfer medium M1 tilts.

When the undercoat ink 36b lands on the image IM1 on the transfer medium M1, it gradually dries. In the process unit region A0 of the transfer medium M1 where the adhesive 111 is applied at the same timing in the adhesive application step ST3, the later the undercoat ink 36b lands, the less dry the undercoat ink 36b is. If the transfer medium M1 tilts, for example due to application of the adhesive 111, the undercoat ink 36b that has not yet dried may drip downward. If the undercoat ink 36b drips downward, bleeding occurs in the transfer image IM1, and image quality of the transfer image IM1 deteriorates.

The printing device 1 of this example solves the above-described problem by delaying the undercoat forming process for the process unit region A0 from an intermediate stage of the undercoat forming process to completion of the undercoat forming process. Note that the delay in the undercoat forming process is performed in such a way that a decrease in throughput in the adhesive application step ST3 is as small as possible. First, referring to FIG. 6, an example of how the process unit region A0 is divided into regions and an example of the number of passes NP of each region are explained. Here, the number of passes NP means the number of times that the main scanning, which accompanies ejection of the undercoat ink 36b, is performed for the same portion on the transfer medium M1.

The process unit region A0 includes the aforementioned regions b1 to b4. FIG. 6 shows an example in which the main scanning and the sub-scanning are performed in units of bands B1 to B6 for the region b1, which is one sheet of cut sheet paper, or for the region b2 at the time of lateral type printing. The control section 10 controls the main scanning that ejects ink 36 while moving the inkjet head 30 relative to the transfer medium M1 along the second direction D2. The control section 10 controls, by moving the colored ink head 31 in the first direction D1 relative to the transfer medium M1 in the sub-scanning between main scannings, to change a position in the first direction D1 where the colored head 32 forms the image IM1 on the transfer medium M1. In addition, the control section 10 controls, by moving the undercoat ink head 32 relative to the transfer medium M1 in the first direction D1 in the sub-scanning, to change a position in the first direction D1 where the undercoat ink head 32 is overlaid the undercoat ink 36b on the image IM1. The image IM1 is formed on the transfer medium M1 in the unit of the bands B1 to B6 in this order in the first direction D1, and the undercoat ink 36b is overlaid on the image IM1 in the unit of the bands B1 to B6 in this order in the first direction D1. The process unit region A0 shown in FIG. 6 includes a first region A1 and a second region A2 in which the undercoat ink 36b is overlaid on the image IM1 after the first region A1. The second region A2 is a region where the undercoat ink 36b is overlaid on the image IM1 in a main scanning after a main scanning in which the undercoat ink 36b is overlaid on the image IM1 in the first region A1. FIG. 6 shows various examples C1 to C3 of dividing the bands B1 to B6 into regions.

In example C1, bands B1 and B2 are assigned to the first region A1, bands B3 and B4 are assigned to the third region A3, and bands B5 and B6 are assigned to the second region A2. The first region A1 includes the band B1 in which the undercoat ink 36b is first overlaid on the image IM1 in the process unit region A0. In the third region A3, the undercoat ink 36b is overlaid on the image IM1 after the first region A1 and before the second region A2. The second region A2 includes the band B6 in which the undercoat ink 36b is lastly overlaid on the image IM1 in the process unit region A0. The control section 10 causes the undercoat forming process for the third region A3 to be delayed, and the undercoat forming process for the second region A2 to be further delayed. In the undercoat forming process shown in FIG. 6, the control section 10 makes the number of passes NP3 for the third region A3 greater than the number of passes NP1 for the first region A1, and makes the number of passes NP2 for the second region A2 greater than the number of passes NP3 for the third region A3. Therefore, it can be said that the control section 10 performs control to delay the undercoat forming process from the band B3, that is in an intermediate stage of the undercoat forming process for the process unit region A0, to completion of the undercoat forming process. It can also be said that the control section 10 performs control to further delay the undercoat forming process from the band B5, that is in an intermediate stage of the undercoat forming process for the process unit region A0, to completion of the undercoat forming process.

As the undercoat forming process is delayed from the intermediate stage of the undercoat forming process for the process unit region A0 to the completion of the undercoat forming process, drying of the undercoat ink 36b in the portion of the process unit region A0 where the undercoat ink 36b was lastly overlaid on the image IM1 progresses. By this, flow of the undercoat ink 36b due to tilting of the transfer medium M1 in the adhesive application step ST3 can be suppressed. By suppressing the flow of the undercoat ink 36b, blurring of the transfer image IM1 caused by the undercoat ink 36b dripping downward is suppressed, and the image quality of the transfer image IM1 is improved.

If the number of passes NP in the second region A2 increases, the time taken for the undercoat forming process for the second region A2 will increase. By this, the undercoat forming process is delayed from the start of the undercoat forming process for the second region A2, and drying of the undercoat ink 36b progresses. If the ejection of the undercoat ink 36b is divided into NP times of main scannings, an ejection amount of the undercoat ink 36b per single main scanning will be less for the second region A2 than for the first region A1, and the undercoat ink 36b will dry more. Therefore, flow of the undercoat ink 36b caused by tilting of the transfer medium M1 in the adhesive application step ST3 is suppressed, and bleeding of the transfer image IM1 is suppressed by a simple method of changing the number of passes NP for each region. In addition, since the third region A3 whose number of passes NP3 is greater than the number of passes NP1 and is less than the number of passes NP2 is located between the first region A1 and the second region A2, a change in the number of passes NP due to a change in the region is reduced. By this, the effect of the change in the number of passes NP on the image quality of the transfer image IM1 is reduced, and the image quality of the transfer image IM1 is improved.

In example C2, the process unit region A0 has no third region A3, bands B1 to B4 are assigned to the first region A1, and bands B5 and B6 are assigned to the second region A2. Even if there is no third region A3, the number of passes NP increases for the second region A2, and thus the undercoat forming process is delayed from the start of the undercoat forming process with respect to the second region A2, and drying of the undercoat ink 36b progresses. Therefore, the flow of the undercoat ink 36b due to tilting of the transfer medium M1 in the adhesive application step ST3 is suppressed, and bleeding of the transfer image IM1 is suppressed. In example C3, only the last band B6 is assigned to the second region A2, and bands B1 to B5 are assigned to the first region A1. In the process unit region A0, the undercoat ink 36b flows most easily in the last band B6. Therefore, also in example C3, the flow of the undercoat ink 36b caused by tilting of the transfer medium M1 in the adhesive application step ST3 is effectively suppressed, and bleeding of the transfer image IM1 is effectively suppressed.

FIG. 7 schematically shows an example of intermittent transport of the continuous paper M11 as the transfer medium M1 used in lateral type printing. Lateral type printing for the continuous paper M11 is a printing method in which ink 36 is ejected from the inkjet head 30 while the inkjet head 30 is being scanned vertically and horizontally with respect to the process unit region A0 of the continuous paper M11 whose transport was stopped, and the continuous paper M11 is transported in the transport direction by the transport amount L1 corresponding to the process unit region A0. In the example shown in FIG. 6, the second direction D2 is the main scanning direction, and the first direction D1 is the sub-scanning direction and also the transport direction. In the adhesive application step ST3, the adhesive 111 is applied to the continuous paper M11 in units of the transport amount L1 at the same timing. Therefore, the process unit region A0 will be the region b2 that corresponds to the single transport amount L1 when the continuous paper M11 is transported intermittently.

In state SA1 shown in FIG. 7, the transport of the continuous paper M11 as the transfer medium M1 is stopped, and printing is performed on a process unit region A01 as the process unit region A0. When the image IM1 is formed in the process unit region A01 and the undercoat ink 36b is overlaid on the image IM1, the transport section 55 transports the continuous paper M11 in the first direction D1 by a predetermined transport amount L1. The transport amount L1 is a distance obtained by adding a predetermined margin to the length of the process unit region A0 in the first direction D1. Next state SA2 is a state in which the transport of the continuous paper M11 is stopped and printing is performed in a process unit region A02 as the process unit region A0. When the image IM1 is formed in the process unit region A02 and the undercoat ink 36b is overlaid on the image IM1, the transport section 55 transports the continuous paper M11 in the first direction D1 by the transport amount L1. Next state SA3 is a state in which the transport of the continuous paper M11 is stopped and printing is performed in a process unit region A03 as the process unit region A0. As described above, the printer 2 forms the image IM1 in the process unit region A0 of the continuous paper M11 that was stopped, then overlays the undercoat ink 36b on the image IM1, and then intermittently transports the continuous paper M11 in the first direction D1 by the transport amount L1.

FIG. 8 schematically shows the process unit region A0 in a cut sheet paper M12. Printing on the cut sheet paper M12 can be performed by any of lateral type printing, serial type printing, or line type printing. FIG. 8 shows an example in which printing by lateral type or serial type is performed on the cut sheet paper M12. If the transfer medium M1 is the cut sheet paper M12, the adhesive 111 is applied to one cut sheet paper M12 at the same timing in the adhesive application step ST3. Therefore, the process unit region A0 will be the region b1 that corresponds to a single cut sheet paper.

Note that in printing in which both the main scanning and the sub-scanning are performed, the difference in the time of deposit of the undercoat ink 36b is greater in the sub-scanning direction than in the main scanning direction. Therefore, by delaying the undercoat forming process from an intermediate stage of the undercoat forming process to completion of the undercoat forming process in the sub-scanning direction rather than the main scanning direction, blurring of the transfer image IM1 is suitably suppressed.

When serial type printing is performed, the transfer medium M1 is transported in the transport direction by a transport amount corresponding to one sub-scanning. There is a difference in the time of deposit of the undercoat ink 36b even in a single main scanning, and the longer the distance of the main scanning is, the greater the difference in the time of deposit of the undercoat ink 36b will be. Therefore, it is also possible to consider that a region corresponding to a single transport amount in the transfer medium M1 as a process unit region A0, and to divide this process unit region A0 into regions in the main scanning direction. In this case, the process unit region A0 will be the region b3, which corresponds to a transport amount for one sub-scanning when performing the sub-scanning for the transfer medium M1 on which serial type printing is performed. In order to reduce waste of the transfer medium M1, in many cases, a plurality of separated images are arranged on the transfer medium M1 in the main scanning direction. Therefore, it causes a difference in the time of deposit of the undercoat ink 36b that is overlaid on the image in the same main scanning. In such a case, by delaying the undercoat forming process from an intermediate stage of the undercoat forming process to completion of the undercoat forming process in one main scanning, flow of the undercoat ink 36b due to tilting of the transfer medium M1 in the adhesive application step ST3 is suppressed. Such a delay in the undercoat forming process can be caused by, for example, increasing the process time of the main scanning for the second region A2.

When the continuous paper on which an image IM1 was formed and the undercoat ink 36b was overlaid on the image IM1 by line type printing, is cut, the adhesive 111 is applied to a single transfer medium obtained from the continuous paper at the same timing in the adhesive application step ST3. Therefore, the process unit region A0 will be the region b4 that corresponds to the single cut transfer medium. In the process unit region A0, the second region A2 is located closer to the printer 2 than the first region A1 is. In the second region A2, the undercoat ink 36b is overlaid on the image IM1 after the first region A1. In such a case, by delaying the undercoat forming process from an intermediate stage of the undercoat forming process for the process unit region A0 to completion of the undercoat forming process, flow of the undercoat ink 36b due to tilting of the transfer medium M1 in the adhesive application step ST3 is suppressed. As an example of a way to delay the undercoat forming process, it can be considered to increase the transport time of the transfer medium M1 for the second region A2.

### 3. SPECIFIC EXAMPLE OF A PROCESS OF PRINTING DEVICE

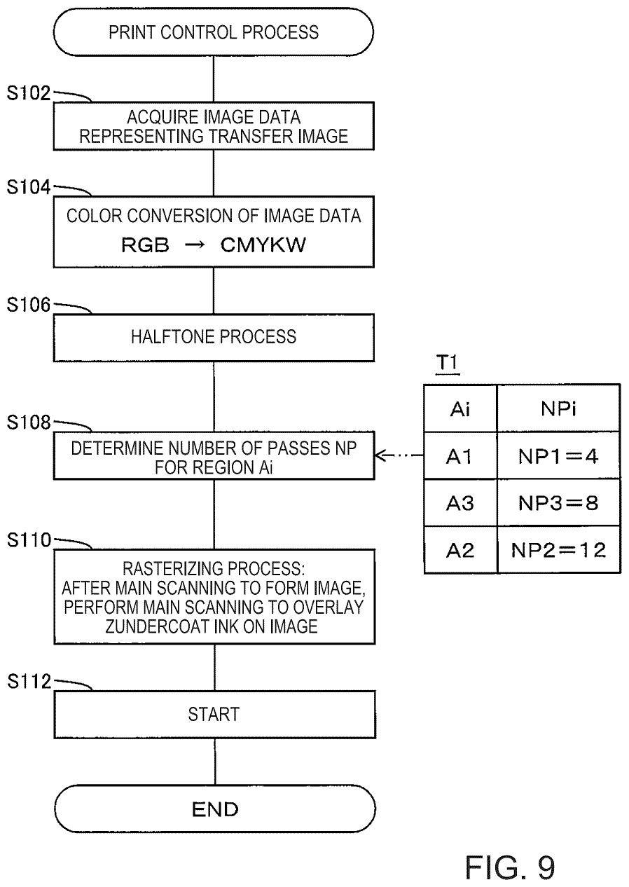

FIG. 9 schematically shows a print control process for performing control to form the image IM1 on the transfer medium M1 and to overlay the undercoat ink 36b on the image IM1. FIG. 9 also shows an example of the structure of a number of passes table T1 that determines the number of passes NP. The printer 2 holds the number of passes table T1, and may store the number of passes table T1 in the storage section 23. The print control process shown in FIG. 9 is intended for lateral type printing or serial type printing. The control section 10 shown in FIG. 4 causes the print control process to start when the control section 10 receives a print instruction for the transfer medium M1 from the host device HO1 or the operation panel 24. When the print control process starts, the control section 10 acquires image data DA1 representing the transfer medium M1 from the host device HO1 or the like (step S102). Hereinafter, the word “step” may be omitted, and reference numerals of steps may be indicated in parentheses.

After acquiring the image data DA1, the control section 10 converts the grayscale value of each pixel into a value representing a usage amount of the colored ink 36a and the undercoat ink 36b (S104). When the image data DA1 is RGB data and the ink amount data is CMYKW data that represents the usage amounts of C, M, Y, K, and W ink 36, the control section 10 converts each pixel value of R, G, and B into each pixel value of C, M, Y, K, and W by referring to a color conversion LUT. The grayscale value of W in the color conversion LUT is, for example, a value that is used for the undercoat ink 36b when at least one colored ink 36a of C, M, Y, and K is used. By this, the undercoat ink 36b is overlaid at a location of the image IM1. The grayscale value of W after color conversion represents an ejection amount of the undercoat ink 36b that will be overlaid on the image IM1 in the process unit region A0. The ejection amount is represented by 0 to 100%, so if the grayscale value of W is between 0 to 255, the grayscale value of W will represent the ejection amount by mapping the grayscale value 0 to 255 to the ejection amount 0 to 100%.

Next, the control section 10 performs a halftone process to generate dot data in which the number of grayscales of the obtained ink amount data is reduced to, for example, 2 or 4 (S106). The dot data is generated for each of C, M, Y, K, and W. After the halftone process, the control section 10 determines the number of passes NPi for each region Ai with reference to the number of passes table T1 (S108). Here, the region Ai is one of the first region A1, the second region A2, and the third region A3. The number of passes NPi is one of the number of passes NP1 to NP3. The number of passes table T1 has the number of passes NP1 associated with the first region A1, the number of passes NP2 associated with the second region A2, and the number of passes NP3 associated with the third region A3. FIG. 9 shows that NP1=4, NP3=8, and NP2=12. In this case, the number of passes NP1 for the first region A1 is 4, the number of passes NP3 for the third region A3 is 8, and the number of passes NP2 for the second region A2 is 12. Therefore, the number of passes NP3 for the third region A3 is larger than the number of passes NP1 for the first region A1, and the number of passes NP2 for the second region A2 is larger than the number of passes NP3 for the third region A3.

After the number of passes NP are determined, the control section 10 performs a rasterizing process to generate raster data by rearranging the dot data so that NPi times of main scannings that overlay the undercoat ink 36b on the image IM1 are performed after the main scanning that forms the image IM1 (S110). For example, it is assumed that the printing section 20 performs NPi times of main scannings that deposit the undercoat ink 36b after one time of main scanning that deposits the colored ink 36a on each band in the process unit region A0. In this case, the control section 10 generates raster data by rearranging the dot data so that the colored ink 36a is ejected to form the image IM1 by one time of main scanning, and then so that the undercoat ink 36b is ejected to overlay the undercoat ink 36b on the image IM1 by NPi times of main scannings. Of course, the main scanning that deposits the colored ink 36a on each band may be performed twice or more, for example, NP times.

Finally, the control section 10 generates a drive signal SG1 in accordance with the raster data and transmits the drive signal SG1 to the inkjet head 30 to control the image forming process that forms the image IM1 on the transfer medium M1, and controls the undercoat forming process that overlays the undercoat ink 36b on the image IM1 by NPi times of main scannings (S112). The ejection amount of the undercoat ink 36b assigned to each time of main scannings may be uniform, or it may be uneven, such as the ejection amount for the NPi-th times scanning is less than the ejection amount for the NPi-1-th times scanning. The drive section 50 moves the inkjet head 30 relative to the transfer medium M1 so that main scanning and sub-scanning are performed in accordance with the control by the control section 10. The colored ink head 31 ejects the colored ink 36a so that the image IM1 is formed on the transfer medium M1 during the main scanning, and the undercoat ink head 32 ejects the undercoat ink 36b so that the undercoat ink 36b is overlaid on the image IM1 during the NPi times of main scannings.

Here, if the number of passes NP is increased in the second region A2 where the undercoat ink 36b is overlaid on the image IM1 after the first region A1 and the third region A3, then the time taken for the undercoat forming process in the second region A2 will increase. By this, the undercoat forming process is delayed from the start of the undercoat forming process for the second region A2, and drying of the undercoat ink 36b progresses. The ejection amount of the undercoat ink 36b per main scanning is less for the second region A2 than for the first region A1 and the third region A3, so drying of the undercoat ink 36b progresses. When drying of the undercoat ink 36b progresses, flow of the undercoat ink 36b due to tilting of the transfer medium M1 in the adhesive application step ST3 is suppressed. Therefore, bleeding of the transfer image IM1 due to the undercoat ink 36b dripping downward or the like is suppressed, and the image quality of the transfer image IM1 is improved. Since the third region A3, whose number of passes NP3 is greater than the number of passes NP1 and is less than the number of passes NP2, is located between the first region A1 and the second region A2, the effect of the change in the number of passes NP for the image quality of the transfer image IM1 is reduced, and the image quality of the transfer image IM1 is improved. Note that in addition to increasing the number of passes NP, a way to delay the undercoat forming process from the intermediate stage of the undercoat forming process may also be to increase the time of the sub-scanning process included in the undercoat forming process for the second region A2.

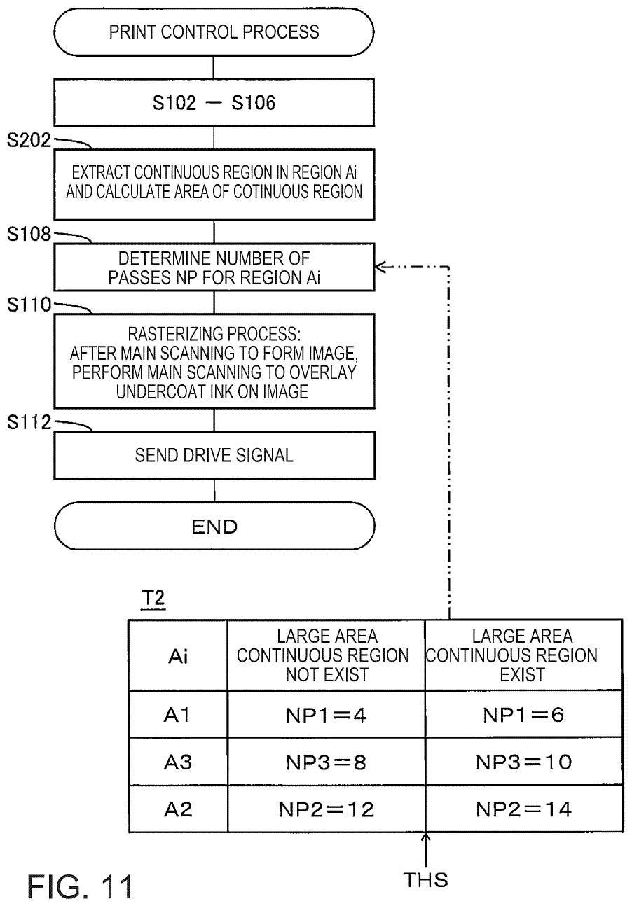

As shown in FIGS. 10 and 11, the control section 10 may change the number of passes NPi for the region Ai in accordance with the area of the continuous region connected to one image as the image IM1. FIG. 10 shows a schematic example of determining whether there is a continuous region that exceeds a reference area THS. FIG. 11 schematically shows another example of the print control process together with another example of the structure of the number of passes table. FIG. 10 shows a first continuous region A11, which has an area S1 that does not exceed a reference area THS, and a second continuous region A12, which has an area S2 that exceeds the reference area THS. The first continuous region A11 is connected as a single image IM1, and the second continuous region A12 is also connected as a single image IM1. In FIG. 10, the first region A1 includes a plurality of first continuous regions A11, the second region A2 includes a first continuous region A11 and a second continuous region A12, and the third region A3 includes a plurality of second continuous regions A12.

The larger the continuous regions (A11 and A12) are, the more easily that flow of the undercoat ink 36b occurs due to tilting of the transfer medium M1 in the adhesive application step ST3. For example, since the first region A1 includes only the first continuous regions A11 that have a small area, flow of the undercoat ink 36b is small in the first continuous region A11 included in the first region A1 even if the transfer medium M1 is tilted in the adhesive application step ST3. Although not shown, if there is a second continuous region A12 that has a large area in the first region A1, then when the transfer medium M1 is tilted in the adhesive application step ST3, flow of the undercoat ink 36b is likely to occur in the second continuous region A12 included in the first region A1. Therefore, the control section 10 makes the number of passes NP1 in the first region A1 when the second continuous region A12 that has a large area exists in the first region A1 larger than the number of passes NP1 when the second continuous region A12 does not exist in the first region A1. By this, drying of the undercoat ink 36b in the first region A1 progresses, flow of the undercoat ink 36b due to tilting of the transfer medium M1 in the adhesive application step ST3 is further suppressed, and bleeding of the transfer image IM1 is further suppressed.

In FIG. 10, since the second region A2 includes the second continuous region A12, which has a large area, when the transfer medium M1 is tilted in the adhesive application step ST3, flow of the undercoat ink 36b is likely to occur in the second continuous region A12 that is included in the second region A2. In particular, flow of the undercoat ink 36b is likely to occur in the second region A2 including a portion where the undercoat ink 36b is lastly overlaid on the image IM1 in the process unit region A0. Although not shown, if the second region A2 has only the first continuous regions A11 that have a small area, then flow of the undercoat ink 36b is less in the first continuous region A11 included in the second region A2 even if the transfer medium M1 is tilted in the adhesive application step ST3. Therefore, the control section 10 makes the number of passes NP2 in the second region A2 when the second continuous region A12 that has a large area exists in the second region A2 larger than the number of passes NP2 when the second continuous region A12 does not exist in the second region A2. By this, drying of the undercoat ink 36b in the second region A2 progresses, flow of the undercoat ink 36b caused by tilting of the transfer medium M1 in the adhesive application step ST3 is further suppressed, and bleeding of the transfer image IM1 is further suppressed.

Note that the number of passes NP1 in the first region A1 may be kept constant while the number of passes NP2 in the second region A2 is changed in accordance with the area of the continuous region, or the number of passes NP2 in the second region A2 may be kept constant while the number of passes NP1 in the first region A1 is changed in accordance with the area of the continuous region. The control section 10 may make the number of passes NP3 in the third region A3 when the second continuous region A12 that has a large area exists in the third region A3 larger than the number of passes NP3 when the second continuous region A12 does not exist in the third region A3.

A number of passes table T2 shown in FIG. 11 also has the number of passes NP1 associated with the first region A1, the number of passes NP2 associated with the second region A2, and the number of passes NP3 associated with the third region A3. However, the number of passes NPi changes according to the area of the continuous region. In FIG. 11, when the second continuous region A12, which exceeds the reference area THS, does not exist in the region Ai, NP1=4, NP3=8, and NP2=12, and when the second continuous region A12 exists in the region Ai, NP1=6, NP3=10, and NP2=14. The number of passes NPi when the region Ai includes the second continuous region A12 is larger than the number of passes NPi when the region Ai does not include the second continuous region A12. The number of passes NPi in the same region may be switched to three or more levels.

The print control process shown in FIG. 11 is different from the print control process shown in FIG. 9 in that the number of passes table T1 has been replaced with the number of passes table T2, and a process of S202 has been added between S106 and S108. When the dot data of each of C, M, Y, K, and W is generated through processes S102 to S106, the control section 10 extracts continuous regions included in region Ai and obtains the area of each continuous region (S202). For example, based on the image data DA1, the RGB data, the ink amount data, or the dot data, the control section 10 extracts continuous regions included in the first region A1, extracts continuous regions included in the second region A2, extracts continuous regions included in the third region A3, and calculates the area of each continuous region. The area of a continuous region can be obtained, for example, by counting the number of pixels included in the continuous region. Next, the control section 10 refers to the number of passes table T2 to determine the number of passes NPi for each region Ai (S108). The control section 10 determines that the continuous region is the second continuous region A12 when the area of the continuous region exceeds the reference area THS, and determines that the continuous region is the first continuous region A11 when the area of the continuous region does not exceed the reference area THS. If the second continuous region A12 exists in region Ai, the control section 10 determines the number of passes NPi in that region Ai to be the number of passes Npi in the “Large area continuous region exists” column, and if the second continuous region A12 does not exist, the control section determines the number of passes NPi in that region Ai to be the number of passes Npi in the “Large area continuous region does not exist” column.

For example, it will be assumed that the: first continuous region A11 and the second continuous region A12 are arranged in the process unit region A0 as shown in FIG. 10. Since the second continuous region A12 does not exist in the first region A1, the control section 10 determines the number of passes NP1 to be 4. Since the second continuous region A12 exists in the third region A3, the control section 10 determines the number of passes NP3 to be 10. Since the second continuous region A12 exists in the second region A2, the control section 10 determines the number of passes NP2 to be 14.

After the number of passes NP are determined, the control section 10 performs a rasterizing process to generate raster data by rearranging the dot data so that NPi times of main scannings that overlay the undercoat ink 36b on the image IM1 are performed after the main scanning that forms the image IM1 (S110). Finally, the control section 10 generates a drive signal SG1 in accordance with the raster data and transmits the drive signal SG1 to the inkjet head 30 to control the image forming process that forms the image IM1 on the transfer medium M1, and controls the undercoat forming process that overlays the undercoat ink 36b on the image IM1 by NPi times of main scannings (S112). In a case where the large area second continuous region A12 exists in the region Ai, the number of passes NPi is increased as compared to a case where the second continuous region A12 dose not exist. Therefore, flow of the undercoat ink 36b due to tilting of the transfer medium M1 in the adhesive application step ST3 is further suppressed. Therefore, bleeding of the transfer image IM1 is further suppressed.

As shown in FIG. 12, the control section 10 may change the number of passes NPi for the region Ai according to the ejection amount DT of the undercoat ink 36b per unit area for each region Ai. Note that the ejection amount DT of the undercoat ink 36b is also referred to as an undercoat ink ejection amount DT. The “ejection amount DT of W” shown in FIG. 12 means the undercoat ink ejection amount DT per unit area. FIG. 12 schematically shows an example in which the number of passes NPi is changed according to the undercoat ink ejection amount DT per unit area. FIG. 12 also shows an example of a structure of a number of passes table T3 for determining the number of passes NPi in accordance with the undercoat ink ejection amount DT.

The number of passes table T3 shown in FIG. 12 also has the number of passes NP1 associated with the first region A1, the number of passes NP2 associated with the second region A2, and the number of passes NP3 associated with the third region A3. However, the number of passes NPi changes according to the undercoat ink ejection amount DT in the region Ai. In FIG. 12, the threshold value of the undercoat ink ejection amount DT per unit area includes a first ejection amount THD1 and a second ejection amount THD2 that is larger than the first ejection amount THD1. When the undercoat ink ejection amount DT for the region Ai does not exceed the first ejection amount THD1, then NP1=2, NP3=3, and NP2=4. When the undercoat ink ejection amount DT for the region Ai exceeds the first ejection amount THD1 but does not exceed the second ejection amount THD2, then NP1=4, NP3=6, and NP2=8. When the undercoat ink ejection amount DT for the region Ai exceeds the second ejection amount THD2, then NP1=8, NP3=12, and NP2=16. Therefore, it can be said that the number of passes table T3 contains information that makes the number of passes NPi for the region Ai to be NP1<NP3<NP2, as long as the undercoat ink ejection amount DT is constant. For each region Ai, the number of passes NPi when the undercoat ink ejection amount DT per unit area exceeds the first ejection amount THD1 is greater than the number of passes NPi when the undercoat ink ejection amount DT per unit area does not exceed the first ejection amount THD1. For each region Ai, the number of passes NPi when the undercoat ink ejection amount DT per unit area exceeds the second ejection amount THD2 is greater than the number of passes NPi when the undercoat ink ejection amount DT per unit area does not exceed the second ejection amount THD2. Therefore, it is also possible to read “second ejection amount THD2” as “first ejection amount THD1”.

Note that in the second region A2, while the number of passes NP2 when DT>THD1 is made to be larger than the number of passes NP2 when DT≤THD1, the number of passes NP1 for the first region A1 may be made to be constant regardless of the undercoat ink ejection amount DT. In addition, in the first region A1, while the number of passes NP1 when DT>THD1 is made to be larger than the number of passes NP1 when DT≤THD1, the number of passes NP2 for the second region A2 may be made to be constant regardless of the undercoat ink ejection amount DT. The same can be applied to the third region A3.

The print control process that refers to the number of passes table T3 can be performed in accordance with the print control process shown in FIG. 9. For example, in S108, the control section 10 may, based on the W data included in the CMYKW data, calculate an average value of the ejection amount of the undercoat ink 36b for the portion to be overlaid on the image IM1 for each region Ai as the undercoat ink ejection amount DT. After that, the control section 10 can select the number of passes Npi corresponding to the calculated undercoat ink ejection amount DT for each region Ai by referring to the number of passes table T3.

As shown in FIG. 12, when the undercoat ink ejection amount DT1 exceeds the second ejection amount THD2 for the first region A1, the control section 10 determines the number of passes NP1 to be 8, which corresponds to “large” in the “first region A1” in the number of passes table T3. When the undercoat ink ejection amount DT3 exceeds the second ejection amount THD2 for the third region A3, the control section 10 determines the number of passes NP3 to be 12, which corresponds to “large” in the “third region A3” in the number of passes table T3. When the undercoat ink ejection amount DT2 does not exceed the first ejection amount THD1 for the second region A2, the control section 10 determines the number of passes NP2 to be 4, which corresponds to “small” in the “second region A2” in the number of passes table T3.

The greater the undercoat ink ejection amount DT per unit area is, the more likely flow of the undercoat ink 36b will occur due to tilting of the transfer medium M1 in the adhesive application step ST3. Since drying of the undercoat ink 36b progresses as the number of passes NP increases in the region where the undercoat ink ejection amount DT is large, flow of the undercoat ink 36b due to tilting of the transfer medium M1 in the adhesive application step ST3 is further suppressed, and bleeding of the transfer image IM1 is suppressed.

Assuming that the undercoat ink ejection amount DT is constant, the control section 10 makes the number of passes NP3 for the third region A3 larger than the number of passes NP1 for the first region A1, and makes the number of passes NP2 for the second region A2 larger than the number of passes NP3 for the third region A3. Therefore, it can be said that the control section 10 performs control to delay the undercoat forming process from an intermediate stage of the undercoat forming process for the process unit region A0 to the completion of the undercoat forming process. By this, drying of the undercoat ink 36b in the portion where the undercoat ink 36b is lastly overlaid on the image IM1 in the process unit region A0 progresses, and flow of the undercoat ink 36b due to tilting of the transfer medium M1 in the adhesive application step ST3 is suppressed. Since the number of passes table T3 shown in FIG. 12 takes into consideration both the number of passes NP and the undercoat ink ejection amount DT related to bleeding of the transfer image IM1, the bleeding of the transfer image IM1 is suitably suppressed.

Although not shown in the drawings, the number of passes NPi in each category of the pass number table T3 shown in FIG. 12 may be changed according to the area of the continuous region. For example, in the second region A2, when DT≤THD1, if there is a second continuous region A12 that exceeds the reference area THS, then NP2=6, but if there is no second continuous region A12, then NP2=4. In the second region A2, when THD1<DT≤THD2, if there is the second continuous region A12 that exceeds the reference area THS, then NP2=10, but if there is no second continuous region A12, then NP2=8. In the first region A1, when DT≤THD1, if there is the second continuous region A12 that exceeds the reference area THS, then NP1=4, but if there is no second continuous region A12, then NP1=2. In the first region A1, when THD1<DT≤THD2, if there is the second continuous region A12 that exceeds the reference area THS, then NP1=6, but if there is no second continuous region A12, NP1=4.

### 4. MODIFIED EXAMPLE

Various modifications of the present disclosure are conceivable. For example, a subject that performs the above processes is not limited to a CPU, and may be an electronic component other than a CPU, such as an application specific integrated circuit (ASIC). Of course, a plurality of CPUS may work together to perform the above processes, or a CPU and another electronic component (for example, an ASIC) may work together to perform the above processes. A part of the print control process shown in FIGS. 9 and 11 may be performed by the host device HO1. In this case, in a narrow sense the control section of the printing device 1 is a combination of the control section 10 and the host device HO1. The combination of colors of colored ink 36a is not limited to C, M, Y, and K, and may include orange, green, light cyan having a low density than C, light magenta having a low density than M, dark yellow having a higher density than Y, light black having a low density than K, and the like. Of course, the aspects of the present application are also applicable to the case where the colored ink 36a does not include some of the colors of C, M, Y, and K.

The undercoat ink 36b is not limited to the W ink, and may be K ink containing a component that absorbs light, gray ink containing a component that causes diffuse reflection and a component that absorbs light, or the like. It is also possible to use clear ink, which allows light to pass through, as the undercoat ink 36b, although the color of the transfer target medium M2 that serves as the background for the image IM1 may pass through.

### 5. CONCLUSION

As described above, according to the present disclosure, it is possible to provide a configuration that can suppress bleeding of the transfer image in various aspects. Of course, the basic operations and effects described above can also be obtained with an aspect consisting only of the independent claim's constituent elements. A configuration in which the respective configurations disclosed in the above-described examples are replaced with each other or combinations thereof are changed, a configuration in which the respective configurations disclosed in the publicly known art and the above-described examples are replaced with each other or combinations thereof are changed, and the like can be implemented. The present disclosure also includes these configurations.

What is claimed is:

1. A printing method for printing on a transfer medium in order to perform an adhesive application step for applying an adhesive on undercoat ink that was overlaid on an image that was formed on the transfer medium, and to perform a transfer step for transferring the image to a transfer target medium by attaching the adhesive to the transfer target medium, the printing method comprising:
an image forming step for performing a first process that forms the image on the transfer medium by ejecting a colored ink from a first inkjet head and
an undercoat forming step for performing a second process including a process of overlaying the undercoat ink on the image on the transfer medium by ejecting the undercoat ink from a second inkjet head, wherein
assuming that a region where the adhesive is applied to the transfer medium at the same timing in the adhesive application step is a process unit region, in the undercoat forming step, the second process for the process unit region is delayed from an intermediate stage of the second process to completion of the second process.

2. The printing method according to claim 1, wherein
the process unit region includes a first region and a second region where the undercoat ink is overlaid on the image after the first region,
the second region includes a portion where the undercoat ink is lastly overlaid on the image in the process unit region, and
in the undercoat forming step, the second process for the second region is delayed.

3. The printing method according to claim 2, wherein
the undercoat forming step performs the second process of a main scanning that ejects the undercoat ink while moving the second inkjet head relative to the transfer medium along a second direction, and of changing a position in a first direction where the undercoat ink is overlaid on the image by moving the second inkjet head relative to the transfer medium in the first direction, which intersects the second direction, during a sub-scanning between main scannings, and
assuming that the number of times that the main scanning that accompanies ejection of the undercoat ink is performed on the same portion of the transfer medium is the number of passes, the undercoat forming step performs the second process that makes the number of passes for the second region greater than the number of passes for the first region.

4. The printing method according to claim 3, wherein
the process unit region includes a continuous region that is connected as one image as the image and
the undercoat forming step makes the number of passes when there is a continuous region that exceeds a reference area in at least one of the first region and the second region greater than the number of passes when there is no continuous region that exceeds a reference area.

5. The printing method according to claim 2, wherein
the undercoat forming step performs the second process of a main scanning that ejects the undercoat ink while moving the second inkjet head relative to the transfer medium along a second direction that intersects the first direction, and of changing a position in a first direction where the undercoat ink is overlaid on the image by moving the second inkjet head relative to the transfer medium in the first direction during a sub-scanning between main scannings, and
assuming that the number of times that the main scanning that accompanies ejection of the undercoat ink is performed on the same portion of the transfer medium is the number of passes, the undercoat forming step performs the second process that makes the number of passes when an ejection amount of the undercoat ink per unit area exceeds a first ejection amount in at least one of the first region and the second region greater than the number of passes when the ejection amount of the undercoat ink per unit area does not exceed a first ejection amount, and that makes the number of passes for the second region greater than the number of passes for the first region when the ejection amount of the undercoat ink per unit area is not changed.

6. The printing method according to claim 1, wherein
the undercoat ink is an ink that contains a component that blocks transmission of light.

7. A printing device that prints on a transfer medium in order to perform an adhesive application step that applies an adhesive on undercoat ink that was overlaid on an image that was formed on the transfer medium, and a transfer step that transfers the image to a transfer target medium by attaching the adhesive to the transfer target medium, the printing device comprising:
a first inkjet head that ejects colored ink;
a second inkjet head that ejects the undercoat ink;
a drive section configured to move the second inkjet head in a first direction relative to the transfer medium; and
a control section that controls ejection of the colored ink from the first inkjet head, ejection of the undercoat ink from the second inkjet head, and the drive section, wherein
the control section
controls a first process that forms the image on the transfer medium by ejecting the colored ink from the first inkjet head,
controls a second process that includes a process that overlays the undercoat ink on the image on the transfer medium by ejecting the undercoat ink from the second inkjet head, and
assuming that a region where the adhesive is applied to the transfer medium at the same timing in the adhesive application step is a process unit region, performs control that delays the second process for the process unit region from an intermediate stage of the second process to the completion of the second process.
